(19) United States
(12) Patent Application Publication
(10) Pub. No.: US 2015/0242689 A1
(43) Pub. Date: Aug. 27, 2015

(54) SYSTEM AND METHOD FOR DETERMINING GRAPH RELATIONSHIPS USING IMAGES

(71) Applicant: SEE-OUT PTY, LTD, TOOWONG (AU)

(72) Inventor: Sandra Mau, Toowong (AU)

(21) Appl. No.: 14/419,795

(22) PCT Filed: Aug. 6, 2013
(86) PCT No.: PCT/IB2013/002175

§ 371 Date: Feb. 5, 2015

Related U.S. Application Data
(60) Provisional application No. 61/679,965, filed on Aug. 6, 2012.
(60) Provisional application No. 61/718,167, filed on Oct. 24, 2012.

(51) Int. Cl. G06K 9/00; G06F 17/30; G06Q 50/00

(52) U.S. Cl. CPC G06K 9/00677; G06Q 50/01; G06F 17/30247

(57) ABSTRACT

A system and method for determining graph relationships using images is disclosed. According to one embodiment, the computer-implemented method includes detecting a first feature from an image, detecting a second feature from the image, matching the first feature with a first identity that is associated with a first reference feature, matching the second feature with a second identity that is associated with a second reference feature, and determining a relationship between the first identity and the second identity based on the first feature co-occurring with the second feature in the image.

The present application claims the benefit of and priority to U.S. Provisional Application Nos. 61/679,965 entitled “Determining Social Graph Relationships Using Photos and Video”, filed on Aug. 6, 2012, and 61/718,167 entitled “Determining Relationships Using Photos and Video”, filed on Oct. 24, 2012, the disclosures of which are incorporated by reference in their entirety, for all purposes, herein.

### FIELD

The present disclosure relates in general to the field of social networks. In particular, the present disclosure relates to a system and method for determining social graph relationships using images.

### BACKGROUND

Web pages typically embed images (e.g., photos and videos) that include text, tags, and/or captions in the HyperText Markup Language (HTML) format. Information may also be embedded into an image file, for example, via exchangeable image file format (EXIF) tags for photo images or variant forms of extensible markup language (XML) data for video files such as extensible metadata platform (XMP). HTML includes tags to structure text and multimedia documents and to set up a hypertext link between documents. Geolocation is a common EXIF data that relates an image with a location where the image was taken.

There are many traditional online services that allow users to connect to other users and share information including image files such as photo files and video clips. These online services are commonly referred to as social network services. These social networks host user-provided images (e.g., photos and videos) as well as commercial images provided by advertisement providers (e.g., advertisement media). Several social network services (e.g., FACEBOOK®, FLICKR®, and GOOGLE+®) and third-party web services (e.g., FACE.COM®'s FACEBOOK® application) provide either manual or semi-automated user interfaces for users to apply a tag or annotation to a face in an image and link the face with a corresponding user's account. A tag or annotation is a location marker that denotes a landmark in an image. For example, a user face tag may be a rectangle or a point on an image that denotes the location of a person's face in the image. A tag may further denote objects such as a product, an animal, a logo, and a brand. Systems and processes that provide automated face tagging or annotation using face recognition are described in U.S. Pat. Pub. No. US2010/0063961 by Guiheneuf, et. al. (hereinafter “Guiheneuf”) entitled “Reverse Tagging of images in System for Managing and Sharing Digital Images”.

Automatic facial recognition is a particular application in the field of computer vision and image processing. It involves comparing two faces and generating a match or similarity score (or distance score) that is a measure the similarity between the two faces. A threshold based on the similarity score is used to classify whether the two faces belong to the same person, or two different people. The process of face recognition involves extraction of one or more types of low-level image features, deriving one or more high level representations of the two faces based on pre-trained models, and comparing the high level representations of the two faces to each other to find the distance or similarity between them using a comparison metric. A survey of facial recognition methods is described by Zhao, at al. (Zhao at al, “Face Recognition: A Literature Survey”, ACM Comput. Surv. 35, pp. 399-458, Dec. 4, 2003) (hereinafter “Zhao”).

Automated object recognition algorithms for images further enable context derivation from images. Object recognition typically includes a detection and an extraction of distinct features from an image. The extracted features typically represent a texture or a pattern as a numeric vector. This object recognition approach can be applied to features such as logos, products, and brands for recognizing trademarks in videos (e.g., sports videos).

Social networks have a social graph structure where users are connected to other users. These social connections typically represent a relationship between users (e.g., family and friendship) and are explicitly requested from a first user to a second user, and approved by the second user.

### SUMMARY

A system and method for determining graph relationships using images is disclosed. According to one embodiment, the computer-implemented method includes detecting a first feature from an image, detecting a second feature from the image, matching the first feature with a first identity that is associated with a first reference feature, matching the second feature with a second identity that is associated with a second reference feature, and determining a relationship between the first identity and the second identity based on the first feature co-occurring with the second feature in the image.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying figures, which are included as part of the present specification, illustrate the presently preferred embodiments of the present invention and together with the general description given above and the detailed description of the preferred embodiments given below serve to explain and teach the principles of the present invention.

FIG. 1 illustrates an exemplary process of deriving a graph relationship between identities from images, according to one embodiment.

FIG. 2 illustrates an exemplary process for building a reference database using tagged images, according to one embodiment.

FIG. 3 illustrates a diagram of an exempla image-based social graph, according to one embodiment.

FIG. 4 illustrates a diagram of another exemplary image-based social graph, according to one embodiment.

FIG. 5 illustrates an exemplary computer architecture that may be used for the present system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

A system and method for determining graph relationships using images is disclosed. According to one embodiment, the computer-implemented method includes detecting a first feature from an mage, detecting a second feature from the image, matching the first feature with a first identity that is associated with a first reference feature, matching the second feature with a second identity that is associated with a second reference feature, and determining a relationship between the first identity and the second identity based on the first feature co-occurring with the second feature in the image.

Each of the features and teachings disclosed herein can be utilized separately or in conjunction with other features and teachings to provide a system and method for determining graph relationships using images. Representative examples utilizing many of these additional features and teachings, both separately and in combination are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. The steps are not intended to be performed in a specific sequential manner unless specifically designated as such.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, and each coupled to a computer system bus.

The methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the method steps. The structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

According to one embodiment, the present system and method derives an image-based social graph between detected features in images such as between users, and between users and objects (e.g., a brand, a product, and a logo), based on identity information associated with, or derived from images (e.g., photos and videos) and sources (e.g., a social network, a blog, a web site, a mobile application, and received images) that provide the images. The identity information of users may include, but is not limited to, a user tag, a label, an annotation, meta data including known user information, information of the user who provides the image, and algorithmic identification through facial recognition. The identity information of objects may include, but are not limited to, a tag, a label, a comment, a link, meth-data, and algorithmic object recognition, such as a logo, a brand, a trademark, and a product image.

According to one embodiment, the present system determines relationship information between detected features of images that are shared online, and via social networks. The present system may identify relationships between detected users that are identified by a face recognition method. The present system may further identify relationships between a detected user and a detected object that are identified respectively by a face recognition method and an object recognition method. Images frequently capture users' physical attendance and participation at various events (e.g., a holiday, a wedding, and a daily activity), a user's interaction with other users, and a user's interaction with and proximity to objects (e.g., a brand, a product, and a logo). For example, a user carries a handbag that displays a brand; a user wears clothes that display a logo; a user consumes a product of a particular brand; and a user stands next to an advertisement. The present system determines a social relationship between users (e.g., a family, a spouse, a friend, and an association) based on a frequency of co occurrence of the users in images. The present system may further include an image of co-occurring users to each co-occurring user's photo album or share the image on behalf of each co-occurring user based on the derived relationships. Similarly, the present system determines an associative relationship between a user and an object based on a frequency of co-occurrence between the user and the object in images. In another embodiment, the present system further determines an associative relationship between a user and an object based on explicit user action such as sharing an image with other users, indicating a preference for an image, selecting a link associated with an image, providing a comment for an image, and selecting an advertisement associated with an image. The relationship between detected features may be further based on other information derived from the image such as a context of the image (such as automated computer vision based place recognition), a geolocation, and other meta-data of the image.

According to one embodiment, the present system determines a measure of familiarity between detected users from images based on a frequency of identity co-occurrences of detected users across multiple images, and a proximity of an identity co-occurrence of users within each image. In another embodiment, the present system determines a measure of influence between an object and a user based on a frequency of identity co-occurrences of the object and the user across multiple images, and a proximity of an identity co-occurrence of the object and the user within each image. The present system may determine a proximity of an identity co-occurrence of a user and am object based on various factors, including, but not limited to, whether the object is being worn by the user whether the object is deliberately featured by the user, and whether the object is displayed in the background of the image. In one embodiment, the present system may determine that an object is worn by a user based on detecting that the object is attached to or overlapping with the user. In another embodiment, the present system may determine that an object is deliberately featured by a user based on measuring that the object has a relatively bigger size than other objects/users in the image. in another embodiment, the present system may determine the depth of an object in an image, i.e., whether the object is in the foreground or the background of the image by determining an image ratio of the object size to the face size in the image. The present system may further determine a real-life ratio of the actual size of the object to the actual size of an average face in real-life. The present system may determine that the object is in the foreground when the image ratio is greater than the real-life ratio. Similarly, the present system determines that the object is in the background when the image ratio is less than the real-life ratio.

According to one embodiment, the present system determines a measure of social reach of a detected feature on other features based on the image-based social graph. In one embodiment, the present system determines a measure of social reach of a user on other users, i.e., a user's degree centrality, based on a number of a user's connections to other users. In another embodiment, the present system determines a measure of social reach (or exposure) of an object on one or more users based on the object's number of appearances and interactions associated with the user(s). The interactions associated with the user(s) include, but are not limited to, a user selects the image, a user provides a preference for the image, a user provides a comment of the image, and a user provides a tag to a feature in the image. The present system may further provide on an analysis on the interactions associated with the user(s). For example, the present system receives a photo posted by user A. The present system detects and identifies features from the photo such as user A and object A. The present system further determines that user A is holding object A based on a detection that object A is attached to user A. The present system may further determine a measure of social reach based on analysis of a comment from user C regarding object A in the photo.

According to one embodiment, the present system further determines a measure of social influence of a detected feature on another feature. in one embodiment, the present system correlates the image-based social graph, a measure of familiarity, a measure of social reach, and one or more metrics that calculates how activity spreads through a social network to determine a weighting of social influence of one user on another user. The activity may include, but is not limited to sharing an image (e.g., providing a post in a TWITTER® application). These metrics include measuring a frequency of posted messages and re-sharing information by and among users. For example, the present system receives a first frequency of posted images by user A, and a second frequency of user B sharing user A's posted images. The present system may determine a weighting of social influence of user A on user based on the first frequency and the second frequency.

According to one embodiment, the present system includes an image-based social graph based on a graph theory and network analysis, here nodes represents detected features, such as users and objects. The present system further includes vertices connecting nodes together, where a vertex represents a relationship between detected features, such as a social relationship between users or an associative relationship between a user and an object. The present system further includes weights on vertices, where the weights provide a measure of the relationship between detected features. It is further contemplated that the present system can include applications based on derived graph relationships to provide alerts or reports to users, companies, and brand managers, remove or obscure a logo, and suggesting appropriate target advertisements and offers to users.

According to one embodiment, the present system performs face feature signature generation and face recognition to derive the identity of users in images. One possible approach is based on a bag-of-words method. The bag-of-words method is derived from natural language processing where the order of the words is ignored in the analysis of documents. In computer vision, the bag-of-words method inspired a similar idea for image representation where the exact order of location of the extracted image features are not preserved.

According to one embodiment, the present system utilizes a probabilistic multi-region histogram approach for face recognition. An exemplary probabilistic multi-region histogram technique is described by Sanderson, et al. (Sanderson et al., “Multi-Region Probabilistic Histograms for Robust and Scalable Identity Interference”, International Conference on Biometrics, Lecture Notes in Computer Science, Vol. 5558, pp. 198-208, 2009) (hereinafter “Sanderson”). The probabilistic multi-region histogram approach proposes that a face is divided into several large regions. According to one embodiment, a closely cropped face is divided into a 3×3 grid resulting in nine regions roughly corresponding to regions of eyes, forehead, nose, cheeks, mouth and jaw regions. Within each region, image features are extracted from smaller patches. Sanderson proposes a method for extracting discrete-cosine transform (DCT) features from 8×8 pixel patches and normalizing the coefficients, keeping only the louver frequency coefficients (the first 16) and discarding the first constant coefficient (resulting in 15 remaining coefficients).

During training, a visual dictionary is built using a mixture of Gaussian's approach to cluster the extracted DCT features and generate likelihood models of visual word as expressed by each Gaussian cluster's principal Gaussian and associated probability distribution function. During evaluation, each extracted DCT feature is compared to the visual dictionary to calculate the posterior probability of the feature vector for every visual word in the visual dictionary. This results in a probabilistic histogram vector with a dimension equivalent to the number of Gaussians in the visual dictionary. The present system generates a probabilistic histogram for each patch and averages them over each face region. The face feature signature is the concatenation of these regional histograms and is the image feature representative of a person's face in an image. Two faces may be compared to determine whether they represent the same person by comparing the two face feature signatures using a distance/similarity metric. Sanderson proposes a method for calculating the L1-norm between the two signatures. The lower the distance, the more likely the two faces are representative of the same person.

According to one embodiment, the present system performs automatic object detection to detect objects (e.g., a logo, a product, and a brand) in an image. Object matching typically involves the detection and extraction of distinct features in an image. According to one embodiment, the present system utilizes the probabilistic multi-region histogram approach described by Sanderson for object recognition. To perform reliable object recognition, it is important that the features extracted from the image are detectable under changes in image scale, noise, illumination and perspective change. The present system detects points that typically lie on high-contrast regions of the image, as object edges. According to one embodiment, the present system utilizes a scale-invariant feature transform (SIFT) or a keypoint detection technique. A SIFT feature or keypoint is a selected image region with an associated descriptor. Keypoints are extracted by a SIFT detector and the associated descriptors are computed by a SIFT descriptor. The present system further calculates the maxima and minima of the result of difference of Gaussians function applied in a scale space to a series of progressively smoothed/blurred versions of the image. The present system assigns a dominant orientation to each keypoint, and analyses the gradient magnitudes and orientation to determine a feature vector. The present system further matches features between images by comparing those features across images using a nearest-neighbor search to find a certain percentage of matches higher than an acceptable threshold.

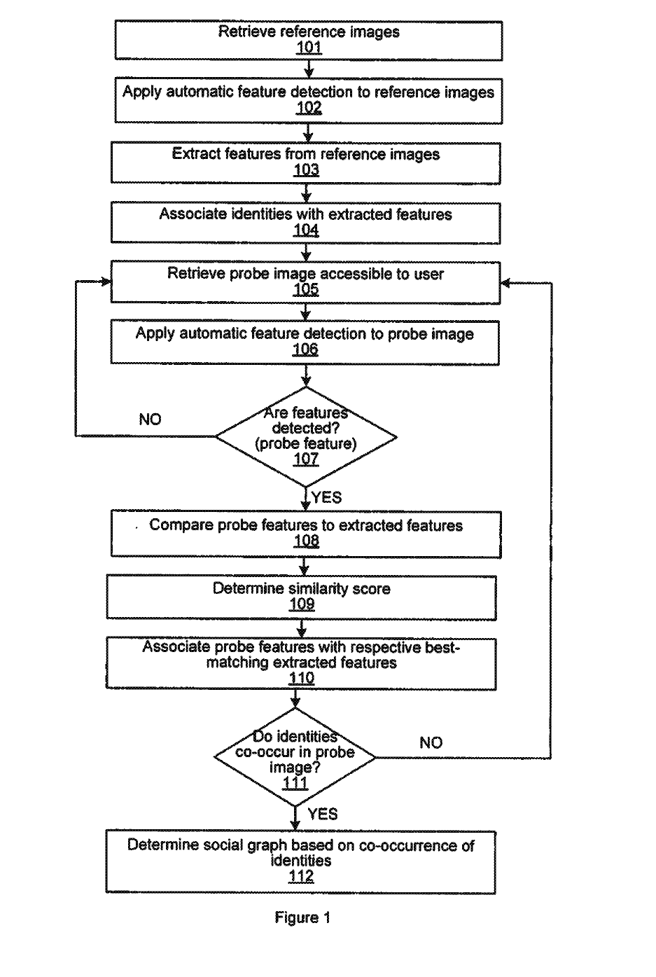

FIG. 1 illustrates an exemplary process of deriving a graph relationship between identities from images, according to one embodiment. At 101, the present system retrieves reference images. According to one embodiment, the reference images are tagged images of users, including images from online albums belonging to the users and the users' connections. According to another embodiment, the reference images are images of objects with known identities, such as brands, logos, and products. At 102, the present system applies automatic feature detection to the reference images. At 103, the present system extracts features from the reference images. At 104, the present system associates identities with respective extracted features. According to one embodiment, the present system associates identity information of a tag with an extracted feature. According to another embodiment, the present system associates a known identity of an image with an extracted feature of the same image. At 105, the present system retrieves a probe image that is accessible to a user. According to one embodiment, the probe age is a part of an online album that belongs to a user or a user's connection. At 106, the present system applies automatic feature detection to the probe image. At 107, the present system determines if features are detected in the probe image. The detected features from the probe image are known as probe features. If probe features are detected, the present system compares each probe feature to the extracted features at 106. At 109, the present system determines a similarity score between each probe feature and each extracted feature. The present system may further store the similarity score in a results database.

At 110, the present system associates a probe feature with a respective best-matching extracted feature. According to one embodiment, the association between a probe feature and a best-matching extracted feature is based on a similarity score satisfying a given threshold. The present system further associates the identity of the extracted feature with the probe feature. At 111, the present system determines if the identities of the probe features co-occur in the probe image.

At 112, the present system determines a social graph based on a co-occurrence of identities in the probe image. According to one embodiment, the social graph structure includes each node representing an identity, and each vertex connecting two nodes represents a co-occurrence of two identities. The present system derives relationship information of co-occurring identities and stores the relationship information in a database. The present system may determine vertices through other forms of user to object association, such as a user posting a photo of a product.

The present system further provides a weighting of a vertex based on various factors including, but not limited to, a proximity between two identities, a user's interaction with another user relating to the image containing an object of interest, such as tagging, sharing, commenting, and selecting (e.g., clicking on the image). For example, the present system provides a weighting of a vertex based on the length between an object to a face (e.g., an object being worn or held by a user, or an object in the background). The present system may determine the length between an object to a face based on the number of pixels between the object and the face. According to one embodiment, the present system may determine the depth of an object in an image, i.e., whether the object is in the foreground or the background of the image by determining an image ratio of the object size to the face size in the image. The present system may further determine a real-life ratio of the actual size of the object to the actual size of an average face in real-life. The present system may determine that the object is in the foreground when the image ratio is greater than the real-life ratio. Similarly, the present system determines that the object is in the background when the image ratio is less than the real-life ratio. The present system may monitor sharing of photos to measure the viralness of a photo as it gets propagated through a social network.

According to one embodiment, the present system records and tallies a frequency of co-occurrences of two or more identities identities across multiple images. The frequency provides a measure or ranking of affinity of influence between the identities. In one embodiment, the frequency provides a cluster of users who are close, thus providing a group for photo albums, viral sharing suggestions, and analysis of demographic information, In another embodiment, the present system further correlates a cluster of users with a time of photo creation to derive a timeline of relationship clusters for a user. In another embodiment, the present system further correlates a cluster of users with a time and a location to determine an effectiveness of an advertising campaign.

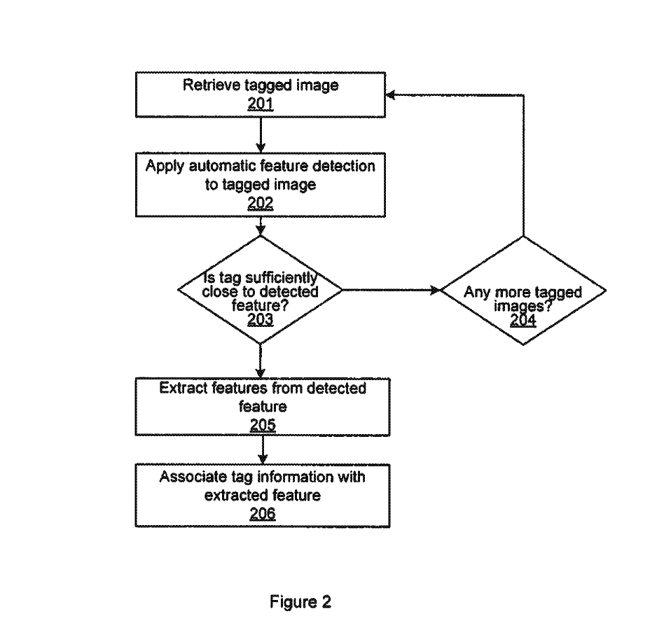

FIG. 2 illustrates an exemplary process for building a reference database using tagged images, according to one embodiment. At 201, the present system retrieves a tagged image. According to one embodiment, the tagged image is a user accessible image that includes tags with identification (e.g., user identification, object identification), such as an image from an online album belonging to a user and the user's connections, or an image from a user's social network account. At 202, the present system applies automatic feature detection to the tagged image. According to one embodiment, the present system detects faces in the tagged image and determines the location of the detected faces. The present system may use the Viola-Jones face detector that runs in real-time for face detection or other face detecting methods known to one skilled in the art. According to one embodiment, the present system detects an object in an image using the SIFT keypoint detection technique. According to another embodiment, the present system scans an object in an image based on a sliding-window detection technique or other object detecting methods known to one skilled in the art. The sliding-window detection technique includes scanning an image with a fixed-size rectangular window and applying a classifier to a sub-image defined by the window. The classifier extracts image features from within the window and returns the probability that the window bounds a particular object. At 203, the present system determines whether the tag is sufficiently close to a detected feature. The tag may be sufficiently close to the detected feature by overlapping the detected feature, being close enough to the detected feature, or being the closest tag to the detected feature. (if multiple tags exist). If there are multiple features in the tagged image, the present system determines the detected feature that the tag is associated with by comparing the length from the tag to the center of each feature and determining the closest length. The system may determine that the tag is sufficiently close to the face by comparing the length from the tag to the center of the feature to a desired limit. According to one embodiment, the desired limit is that the length from the tag to the center of a detected face is less than three times the length between the eyes of the detected face. The system may use other thresholds to determine that the tag is sufficiently close to the face. If the tag is not sufficiently close to the detected face, the system determines whether there are any more tagged photos to apply automatic face detection at 204.

At 205, the present system extracts features from the detected feature. According to one embodiment, the present system extracts features from a detected face to a face feature signature that is a histogram signature based on the probabilistic multi-region histogram. Extracting the face feature signature of the detected face may include cropping the face, performing pre-processing steps (e.g., normalization, scaling, and filtering), extracting low level image features (e.g., patterns in the face). The present system further converts the low level image features to a face feature signature by comparing the features to a dictionary of probabilistic models and generating a probabilistic histogram signature of the face. The present system may further consolidate face feature signatures into one cluster by using a single representative signature. In one embodiment, the present system uses a K-means clustering approach. However, it is contemplated that any other clustering approach known in the art may be used without deviating from the present subject matter. The present system may further verify the face feature signature by comparing the face feature signature to existing signatures of a person and determining whether the match is close enough for acceptance. At 206, the present system associates the tag information with the extracted feature.

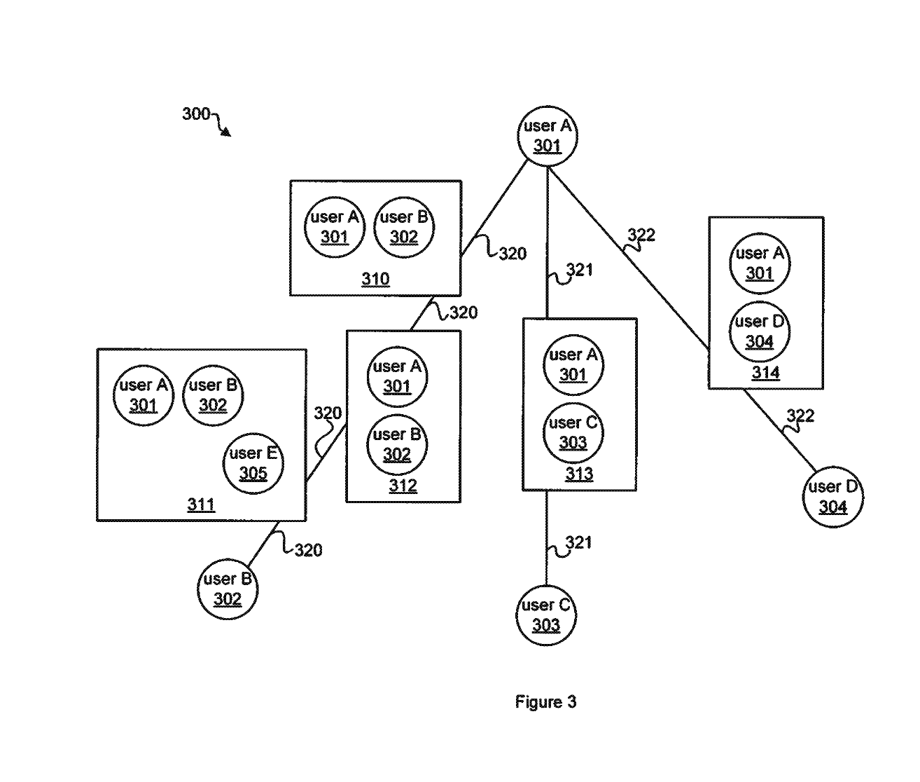

FIG. 3 illustrates a diagram of an exemplary image-based social graph, according to one embodiment. The social graph 300 includes four nodes representing user A 301, user B 302, user C 303, and user D 304. A vertex (as indicated by a line 320) connecting user A 301 and user B 302 indicates a relationship between user A 301 and user B 302. The relationship between user A 301 and user B 302 is based on a co-occurrence of user A 301 and user B 302 in each of images 310-312. User A 301 and user B 302 may co-occur with other users in the same image, for example, with user E 305 in image 311.

A vertex (as indicated by a line 321) connecting user A 301 and user C 303 indicates a relationship between user A 301 and user C 303. The relationship between user A 301 and user C 303 is based on a co-occurrence of user A 301 and user C 303 in image 313. Similarly, a vertex (as indicated by a line 322) connecting user A 301 and user D 304 indicates a relationship between user A 301 and user D 304. The relationship between user A 301 and user D 304 is based on a co-occurrence of user A 301 and user D 304 in image 314. Although FIG. 3 only illustrates four nodes, it is understood that the present system is scalable and may include any number of nodes connected by any number of vertices and any number of images.

According to one embodiment, the present system provides a ranking of familiarity between users based on a frequency of co-occurrences. For example, the vertex (as indicated by the line 320) that indicates three co-occurrences of user A 301 and user B 302 in images 310-312 has a higher ranking than the vertex (as indicated by the line 321) that only indicates one co-occurrence of user A 301 and user C 303 in image 313. This indicates that user A 301 has a closer relationship to user B 302 than user A 301 with user C 303.

According to one embodiment, the present system provides a user with a suggestion of a connection to another user otherwise unknown to him/her. For example, user B 302 may be unaware of a relationship between user A 301 and user D 304, as indicated by the vertex (as indicated by the line 322). The present system provides user B 302 with a friend suggestion of user D 304 based on the relationship between user A 301 and user D 304, as indicated by the vertex (as indicated by the line 322).

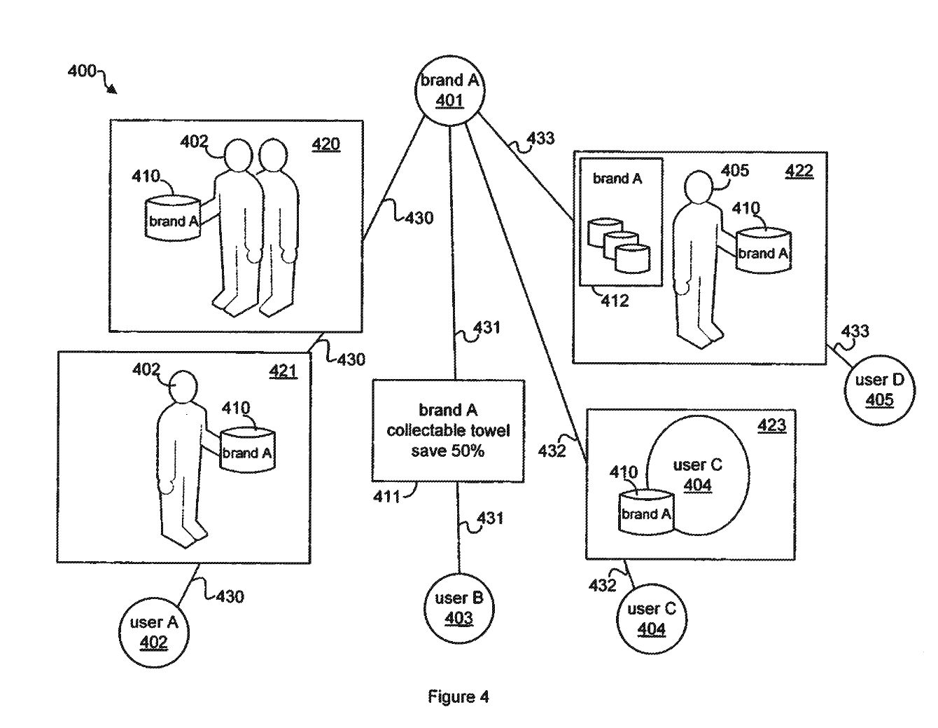

FIG. 4 illustrates a diagram of another exemplary image-based social graph, according to one embodiment. The social graph 400 includes three nodes, representing brand A 401, user A 402, and user B 403. A vertex (as indicated by a line 430) connecting brand A 401 and user A 402 indicates a relationship between brand A 401 and user A 402. The relationship between brand A 401 and user A 402 is based on a co-occurrence of brand A 401 and user A 402 in each of images 420-421. Image 420 displays user A 402 holding a product 410 displaying brand A 401. Similarly, image 421 displays user A 402 holding the product 410 displaying brand A 401. The present system further determines that there is an influence of brand A 401 on user A 402 and use this influence to target advertising opportunities of brand A 401 to user A 401.

The social graph 400 further includes a vertex (as indicated by a line 431) connecting brand A 401 and user B 403, thus indicating a relationship between brand A 401 and user B 403. The relationship between brand A 401 and user B 403 is based on user action of user B 403, such as selecting (e.g., clicking), indicating a preference for, and sharing an advertisement 411 of brand A 401.

The social graph 400 further includes a vertex (as indicated by a line 432) connecting brand A 401 and user C 404, thus indicating a relationship between brand A 401 and user C 404. The relationship between brand A 401 and user C 404 is based on a display of the product 410 in proximity to the face of user C 404 in image 423. The social graph 400 further includes a vertex as indicated by a line 433) connecting brand A 401 and user D 405, thus indicating a relationship between brand A 401 and user D 405. The relationship between brand A 401 and user D 405 is based on a co-occurrence of user D 405 and the product 410 displaying brand A 401, as well as an advertisement 412 of brand A 401 in image 422. It is contemplated that the present system can perform person detection so that the relationship between brand A 401 and user D 405 is also based on a proximity of the product 410 to other parts of user D 405's body. According to one embodiment, the present system determines a social reach for exposure) of brand 401 based on a relationship between brand A and other users (e.g., user A 402, user B 403, user C 404, and user D 405).

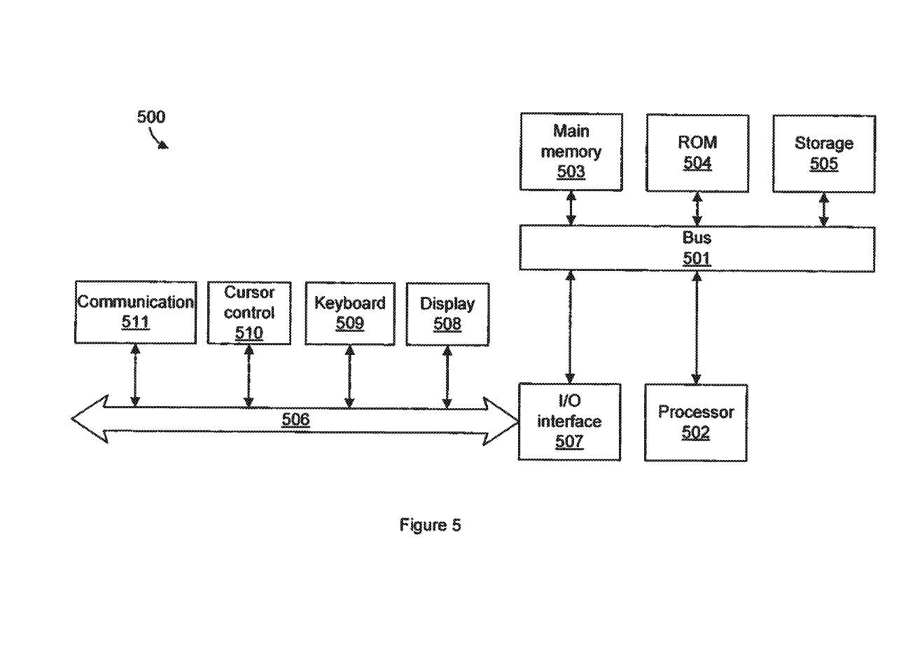

FIG. 5 illustrates an exemplary computer architecture that may be used for the present system, according to one embodiment. The exemplary computer architecture may be used for implementing one or more components described in the present disclosure including, but not limited to, the present system. One embodiment of architecture 500 includes a system bus 501 for communicating information, and a processor 502 coupled to bus 501 for processing information. Architecture 500 further includes a random access memory (RAM) or other dynamic storage device 503 (referred to herein as main memory), coupled to bus 501 for storing information and instructions to be executed by processor 502. Main memory 503 also may be used for storing temporary variables or other intermediate information during execution of instructions by processor 502. Architecture 500 may also include a read only memory (ROM) and/or other static storage device 504 coupled to bus 501 for storing static information and instructions used by processor 502.

A data storage device 505 such as a magnetic disk or optical disc and its corresponding drive may also be coupled to architecture 500 for storing information and instructions. Architecture 500 can also be coupled to a second I/O bus 506 via an I/O interface 507. A plurality of 110 devices may be coupled to I/O bus 506, including a display device 508, an input device (e.g., an alphanumeric input device 509 and/or a cursor control device 510).

The communication device 511 allows for access to other computers (e.g., servers or clients) via a network. The communication device 511 may include one or more modems, network interface cards, wireless network interfaces or other interface devices, such as those used for coupling to Ethernet, token ring, or other types of networks.

The above example embodiments have been described hereinabove to illustrate various embodiments of implementing a system and method for determining graph relationships using images. Various modifications and departures from the disclosed example embodiments will occur to those having ordinary skill in the art. The subject matter that is intended to be within the scope of the invention is set forth in the following claims.

We claim:

1. A computer-implemented method, comprising:
detecting a first feature from an image;
detecting a second feature from the image;
matching the first feature with a first identity that is associated with a first reference feature;
matching the second feature with a second identity that is associated with a second reference feature; and
determining a relationship between the first identity and the second identity based on the first feature co-occurring with the second feature in the image.

2. The computer-implemented method of claim 1, further comprising determining a measure of familiarity between the first identity and the second identity based on one or more of a frequency of the first feature co-occurring with the second feature in a plurality of images, and a proximity of the first feature to the second feature in the image, wherein the first feature comprises a first user, and wherein the second feature comprises a second user.

3. The computer-implemented method of claim 2, further comprising determining a measure of social reach of the first identity on a plurality of identities based on a frequency of the first feature co-occurring with a plurality of features in the plurality of images, wherein the plurality of features comprises users.

4. The computer-implemented method of claim 3, further comprising determining a measure of social influence of the first identity on the second identity based on one or more of the measure of familiarity, the measure of social reach, and user activity.

5. The computer-implemented method of claim 1, wherein the user activity comprises posting the image and sharing the image.

6. The computer-implemented method of claim 1, further comprising determining a measure of influence of the first identity on the second identity based on a frequency of the first feature co-occurring with the second feature in a plurality of images, and a proximity of the first feature to the second user in the image, wherein the first feature comprises an object, and herein the second feature comprises a user.

7. The computer-implemented method of claim 6, further comprising determining the proximity of the first feature to the second feature based on a size ratio of the first feature to the second feature.

8. The computer-implemented method of claim 6, further comprising determining a measure of social reach of the first feature on a plurality of features based on a frequency of the first feature co-occurring with a plurality of features co-occurring in the plurality of images, wherein the plurality of features comprises users.

9. The computer-implemented method of claim 8, wherein determining the measure of social reach is further based on a user action that comprises one or more of selecting the image, indicating a preference for the mage, providing a comment, providing a tag in the image, selecting a link associated with the image, and selecting an advertisement associated with the image.

10. The computer-implemented method of claim 1, wherein determining the relationship between the first identity and the second identity is further based on one or more of place recognition, geo-location, and meta-data of the image.

11. The computer-implemented method of claim 1, wherein the first identity is based on a tag proximity with the first reference feature.

12. The computer-implemented method of claim 1, wherein the first identity is based on a known identity of the first reference feature.

13. A non-transitory computer readable medium having stored thereon computer readable instructions, and at least one processor coupled to the non-transitory computer readable med um wherein the processor executes the instructions to:
detect a first feature from an image;
detect a second feature from the image;
match the first feature with a first identity that is associated with a first reference feature;
match the second feature with a second identity that is associated with a second reference feature; and
determine a relationship between the first identity and the second identity based on the first feature co-occurring with the second feature in the image.

14. The non-transitory computer readable medium of claim 13, wherein the processor executes the instructions to determine a measure of familiarity between the first identity and the second identity based on one or more of a frequency of the first feature co-occurring with the second feature in a plurality of images, and a proximity of the first feature to the second feature in the image, wherein the first feature comprises a first user, and wherein the second feature comprises a second user.

15. The non-transitory computer readable medium of claim 14, wherein the processor executes the instructions to determine a measure of social reach of the first identity on a plurality of identities based on a frequency of the first feature co-occurring with a plurality of features in the plurality of images, wherein the plurality of features comprises users.

16. The non-transitory computer readable medium of claim 15, wherein the processor executes the instructions to determine a measure of social influence of the first identity on the second identity based on one or more of the measure of familiarity, the measure of social reach, and user activity.

17. The non-transitory computer readable medium of claim 16, wherein the user activity comprises posting the image and sharing the image.

18. The non-transitory computer readable medium of claim 13, wherein the processor executes the instructions to determine a measure of influence of the first identity on the second identity based on a frequency of the first feature co-occurring with the second feature in a plurality of images, and a proximity of the first feature to the second user in the image, wherein the first feature comprises an object, and wherein the second feature comprises a user.

19. The non-transitory computer readable medium of claim 18, wherein the processor executes the instructions to determine the proximity of the first feature to the second feature based on a size ratio of the first feature to the second feature.

20. The non-transitory computer readable medium of claim 18, wherein the processor executes the instructions to determine a measure of social reach of the first feature on a plurality of features based on a frequency of the first feature co-occurring with a plurality of features co-occurring in the plurality of images, wherein the plurality of features comprises users.

21. The non-transitory computer readable medium of claim 20, wherein the processor executes the instructions to determine the measure of social reach is further based on a user action that comprises one or more of selecting the image, indicating a preference for the image, providing a comment, providing a tag in the image, selecting a link associated with the image, and selecting an advertisement associated with the image.

22. The non-transitory computer readable medium of claim 13, wherein the processor executes the instructions to determine the relationship between the first identity and the second identity is further based on one or more of place recognition, geo-location, and meta-data of the image.

23. The non-transitory computer readable medium of claim 13, wherein the first identity is based on a tag in proximity with the first reference feature.

24. The non-transitory computer readable medium of cam 13, wherein the first identity is based on a known identity of the first reference feature.
